(19) United States
(12) Patent Application Publication
(10) Pub. No.: US 2004/0038720 A1
(43) Pub. Date: Feb. 26, 2004

(54) Card game of chance

(76) Inventor: Charles Valente, Southington, CT (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 10/645,688

(22) Filed: Aug. 20, 2003

Related U.S. Application Data
(60) Provisional application No. 60/404,640, filed on Aug. 20, 2002.

(51) Int. Cl. A63F 13/00

(52) U.S. Cl. 463/11; 273/292

(57) ABSTRACT

A method for playing a card game by a plurality of players is disclosed. The game is a variation of Gin Rummy and has two pots including wagers by the players. The method includes the steps of pairing the players; providing a deck of cards to each pairing; establishing a target numerical value for completion of the card game and having each of the players of a pairing place a first wager on results of a play of a hand of the card game in a first pot and all of the players place a second wager on results of a complete play of the card game in a second pot. Play begins when a cards are dealt to each player in a pairing in a face down manner, one card is placed in a face up manner and the remaining undealt cards are placed in a face down manner. A first player draws one card from either a top card of the remaining undealt cards or the face up card. The first player then discards a card and, if possible, signals an end of a hand of play. End of play of a hand is followed by each player of the pairing displaying their playing cards; determining a difference in unmatched cards held by each player; tallying a score for the signaling player, in accordance with predetermined rules; and paying the signaling player the first pot. The game ends when at least one of the players achieves a score that is greater than the target numeric value and the player is paid the second pot.

### CROSS-REFERENCE TO RELATED APPLICATIONS

This patent application claims the benefit of U.S. Provisional Patent Application Serial Number 60/404,640, entitled “CARD GAME OF CHANCE” that was filed on Aug. 20, 2002. The disclosure of this patent document is incorporated by reference in its entirety as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to games of chance and, more particularly, to a card game with one or more cash payouts adapted for casino gaming and for leisure activity.

2. Description of Prior Art

Card games and, particularly, rummy-type card games, are well known in the art. Gin Rummy is one of the most popular forms of rummy-type card games. Gin Rummy is generally played by at least two players, each receiving ten cards. A conventional deck of fifty-two playing cards is used. The cards are of one of four suits (e.g., hearts, diamonds, clubs and spades) and are ranked, from low to high, as: Ace, two, three, four, five, six, seven, eight, nine, ten, Jack, Queen, and King. The cards of each suit have point values as follows:

| | |
|---|---|
| Face cards (King, Queen, and Jack) | ten points |
| Ace | one point; and |
| Number cards (2, 3, . . . , 10) | Their numeric value. |

The object of Gin Rummy is to arrange as many as possible of the ten cards in a player's hand into sets. There are two kinds of sets, sequences and groups. A sequence consists of three or more cards of the same suit in consecutive order such as, for example, four of clubs, five of clubs, and six of clubs, or eight of clubs, nine of clubs, ten of clubs, and Jack of clubs. A group is three or four cards of the same rank of different suits such as, for example, seven of clubs, seven of diamonds, and seven of hearts. A card can belong to only one set at a time. For example, a player cannot use the same card as part of both a sequence and a group.

While there are many variations of Gin Rummy, a typical hand is played as follows. First, each play is dealt a predetermined number of playing cards, for example, ten cards. The cards are dealt in a “face down” position so that only the player receiving a card knows the suit and value of the cards in their hand. One card is also placed in a “face up” position, where its suit and value is apparent to all of the players. The remaining cards in the deck are placed in close proximity to the face up card. The remaining cards are in the face down position so that the suit and value of each card is not known to the players.

Next, one of the players draws an additional card and adds it to his or her hand. The additional card may be drawn from the remaining cards in the deck, in which case only the player drawing the card knows the card's suit and value, or the player may draw the card placed in the face up position. Once a card is drawn the player must discard a card such that ten cards are in each players' hand during play. The player may discard the card drawn or another card in his or her hand. However, if the player draws the card in the face up position, then that card cannot be immediately discarded. That is, once drawn, the face up card must be held for at least one turn. The discarded card is placed in the face up position on top of the first face up card (if that card was not drawn). Discarded cards accumulate next to the remaining cards in the deck. Play continues as a next player draws a card. The next player may draw the top card from the remaining cards in the deck or the top card in the discarded pile of cards.

Play of the hand continues in this manner until one of the players places his or her cards into the aforementioned sets, e.g. sequence or groups, to achieve a winning hand. Typically, this is referred to as “knocking.” Remaining cards from the knocking player's hand that are not within a set are generally referred to as unmatched cards. To win, the total value of unmatched cards must be ten points or less. Knocking with no unmatched cards is referred to as “going gin” and, typically, earns an extra score.

Once a player knocks, the non-knocking players are required to display their cards in a face up manner. The knocking player accumulates points both from the fact that he or she won the hand (by knocking) and from an accumulation of points from the cards held by the non-knocking players. Rules vary for determining the points derived from knocking and from the cards in other players' hands. Typically, each of the players counts the total point value of their unmatched cards. If the knocking player's count is lower than a player, the knocking player scores the difference between the two counts. If the knocking player did not go gin and the counts are equal or the knocking player's count is greater than any of the non-knocking players, than the knocking player has been “undercut” or “back doored.” In which case, the non-knocking player may receive bonus points plus the difference between their unmatched cards and the knocking player's cards.

If the knocking player did not go gin and the knocking player is not undercut, then the non-knocking players may be allowed to use their unmatched cards to extend sets laid down by the knocking player. For example, if the knocking player has a set including a group of three consecutive cards of a suit, then the non-knocking player may add a fourth consecutive card in the suit to the knocking player's set. This is typically referred to as “laying off” cards.

As should be appreciated, it is desirable to the non-knocking players to lay off cards to reduce the total point value of unmatched cards in a player's hand. When the non-knocking player's lay off cards, they reduce the amount of points earned by the knocking player for winning the hand (e.g., the aforementioned difference calculation would be lower). If the knocking player goes gin, non-knocking players are typically not allowed to lay off unmatched cards. Typically, the knocking player is not allowed to lay off any cards onto another player's sets.

Play of a hand may also end if there are a limited number of cards (e.g., only two cards) remaining in deck. If no player knocks before the cards run low, the hand is cancelled, no score is given to any player and a new hand is dealt.

Generally speaking, a game of Gin Rummy ends when one player has accumulated a predetermined number of points by winning a number of previously played hands. For example, in some conventional games, the first player to achieve a score of at least one hundred points wins a game.

In one variation of Gin Rummy, referred to as Oklahoma Gin, the original face up card determines the maximum count of unmatched cards with which a player may knock. For example, if a seven of clubs is the initial face up card, then in order for any player to knock the total numeric value of unmatched cards in that player's hand must be seven or less. If the initial face up card is a face card (Jack, Queen or King), then the knock value is ten or less. If the initial face up card is an ace, then a player must go gin. In Oklahoma Gin the points needed to win a game are one hundred and fifty rather than one hundred.

In many areas, it is legal to place a wager (e.g., a monetary amount) on the results of card games and other games of chance and the winner is compensated from a pool of money referred to as a pot. Establishments (e.g., casinos, card rooms and the like) provide dealers, playing cards, tables, chairs and other items of interest to players. Players may play against the establishment. In such a case, the establishment is compensated for providing the facility from its own winnings. Alternatively, the establishment does not participate in play of the games but, instead, receives compensation from each player in exchange for their participation in games or by receiving a percentage of the amounts bet from a winning player's proceeds. In such a case, the players compete against each other and not the establishment.

### SUMMARY OF THE INVENTION

A method for playing a card game by a plurality of players is disclosed. In one embodiment, the game is a variation of Gin Rummy and has two pots that are established and supplemented by antes and wagers by the players. The method includes the steps of pairing the players; providing a deck of cards to each pairing; establishing a target numerical value for completion of the card game and having each of the players of a pairing place a first wager on results of a play of a hand of the card game in a first pot and all of the players place a second wager on results of a complete play of the card game in a second pot. Play begins when cards are dealt to each player of a pairing in a face down manner, one card is placed in a face up manner and the remaining undealt cards are placed in a face down manner. A first player draws one card from either a top card of the remaining undealt cards or the face up card. The first player then discards a card and, if possible, signals an end of a hand of play. End of play of a hand is followed by each player of a pairing displaying their playing cards; determining a difference in unmatched cards held by each player in the pairing; tallying a score for the signaling player, in accordance with predetermined rules; and paying the signaling player the first pot. The game ends when at least of the players achieves a score that is greater than the target numeric value, and the player is paid the second pot.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified block diagram representation of the inventive card game;

FIGS. 2A and 2B are simplified block diagrams of the game and hand pots in accordance with one embodiment of the present invention;

FIGS. 3A, 3B, 3C and 3D is a flow diagram illustrating steps and a method of play of the card game in accordance with one embodiment of the present invention; and

FIG. 4 is a simplified graphical representation of an electronic video game format implementing one embodiment of the present invention.

In these figures, like structures are assigned like reference numerals, but may not be referenced in the description for all figures.

### DETAILED DESCRIPTION OF THE PREFERRED EMBODIMENTS

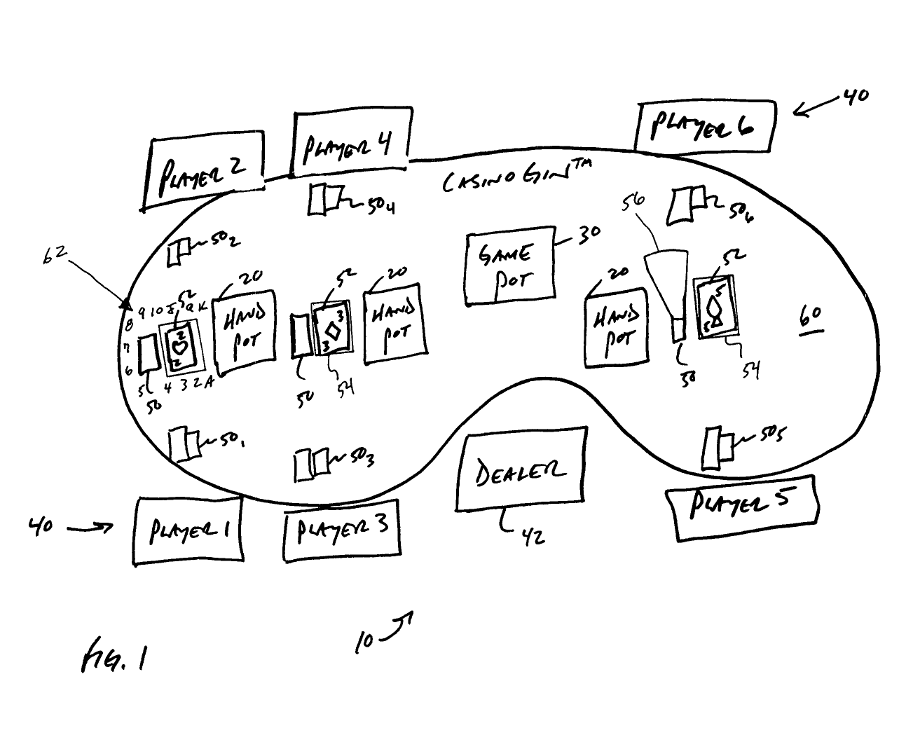

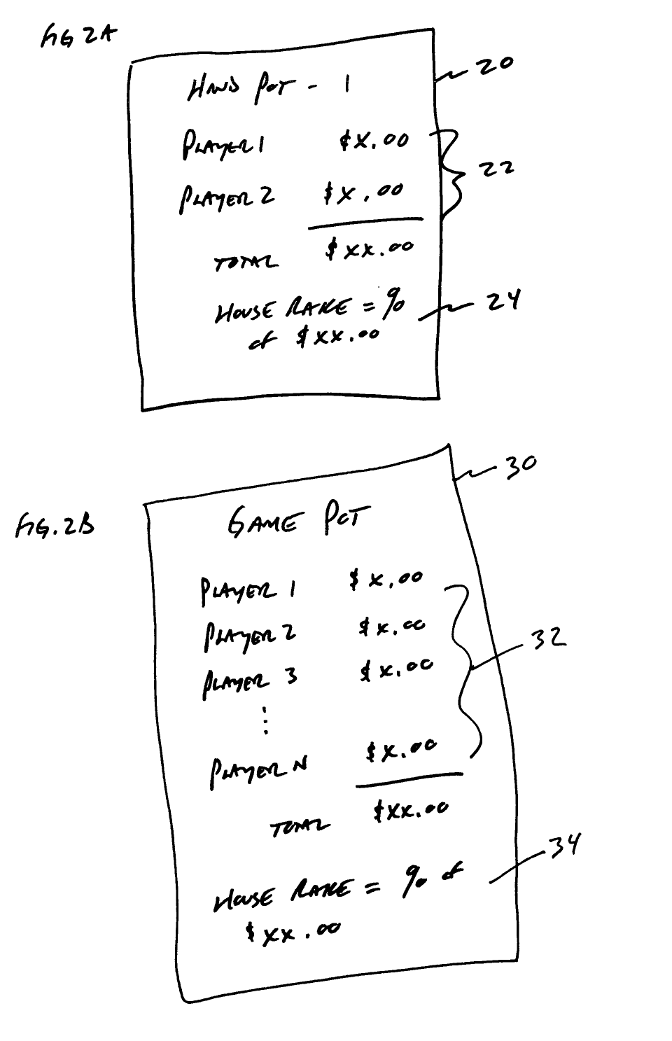

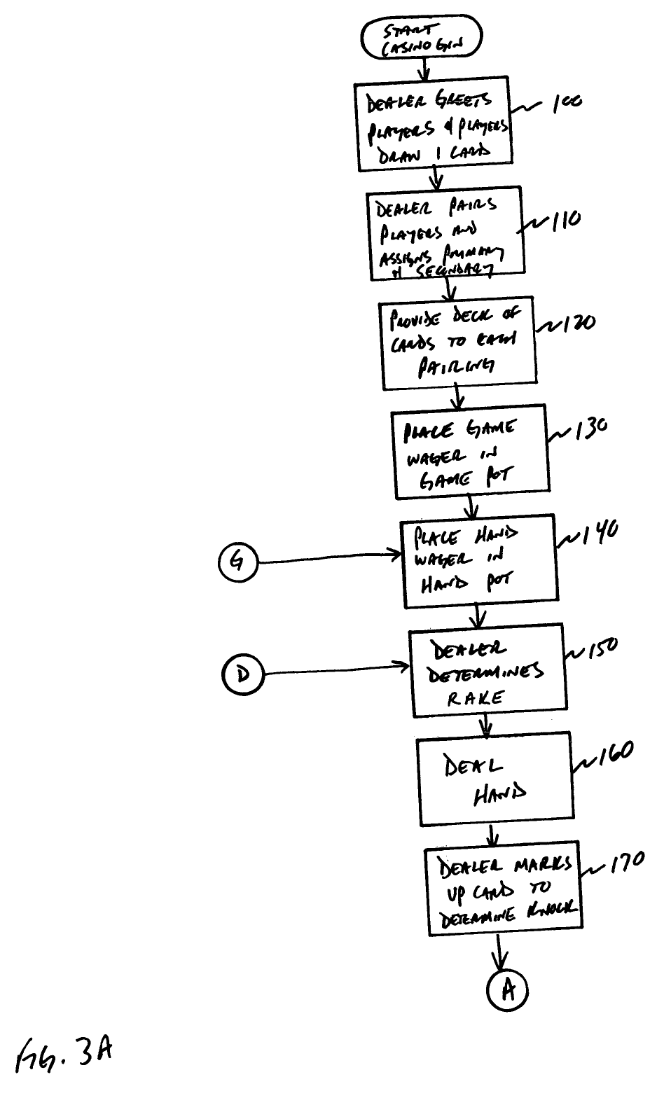

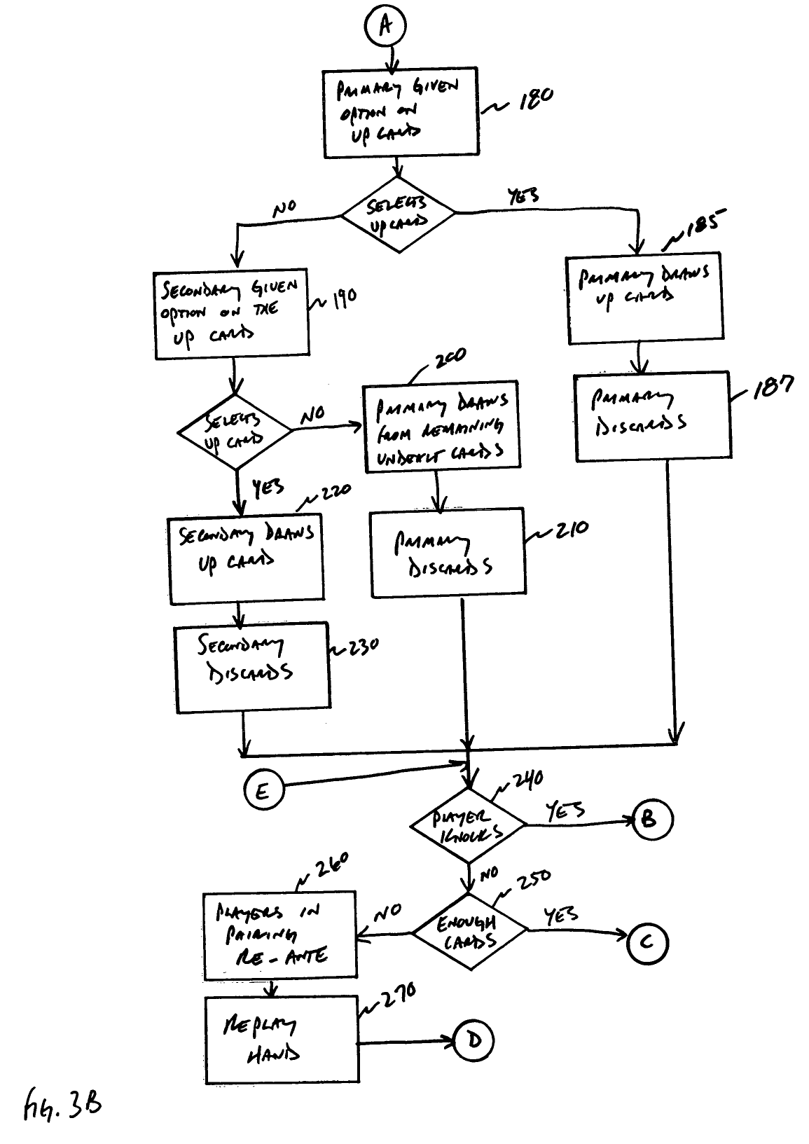

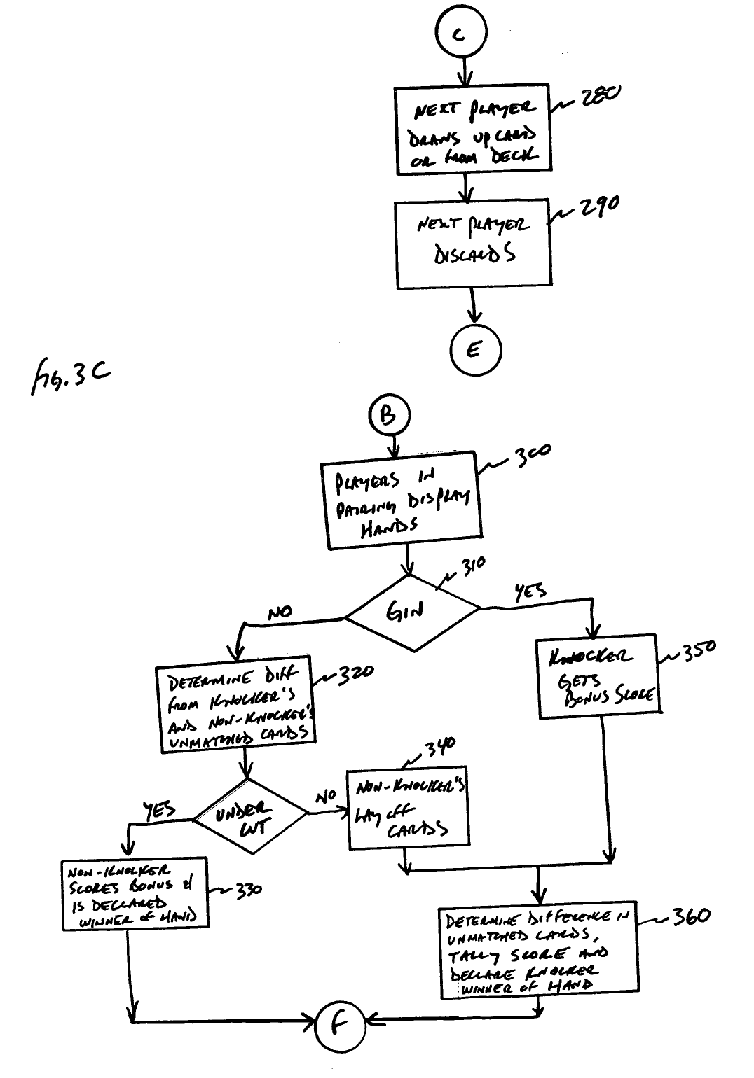

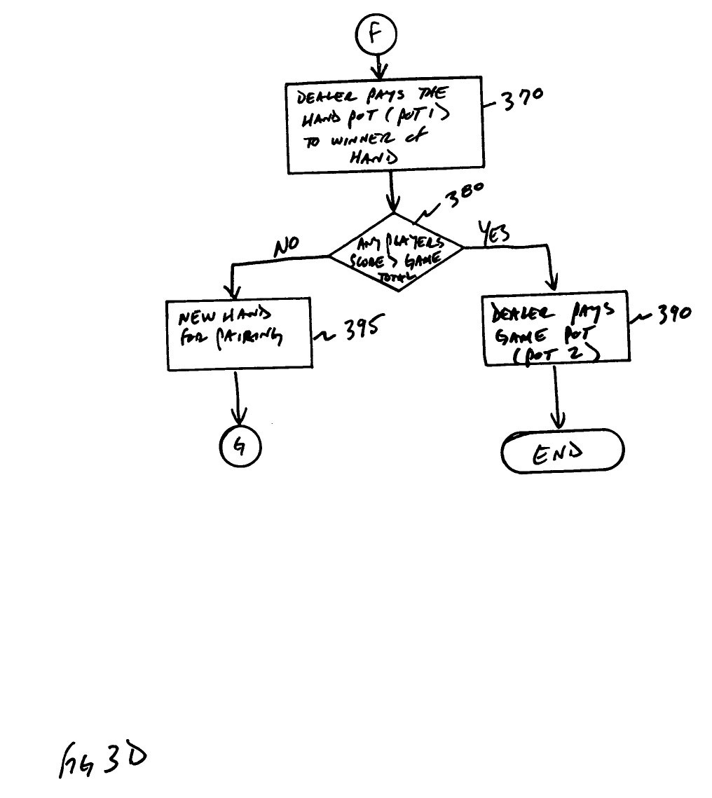

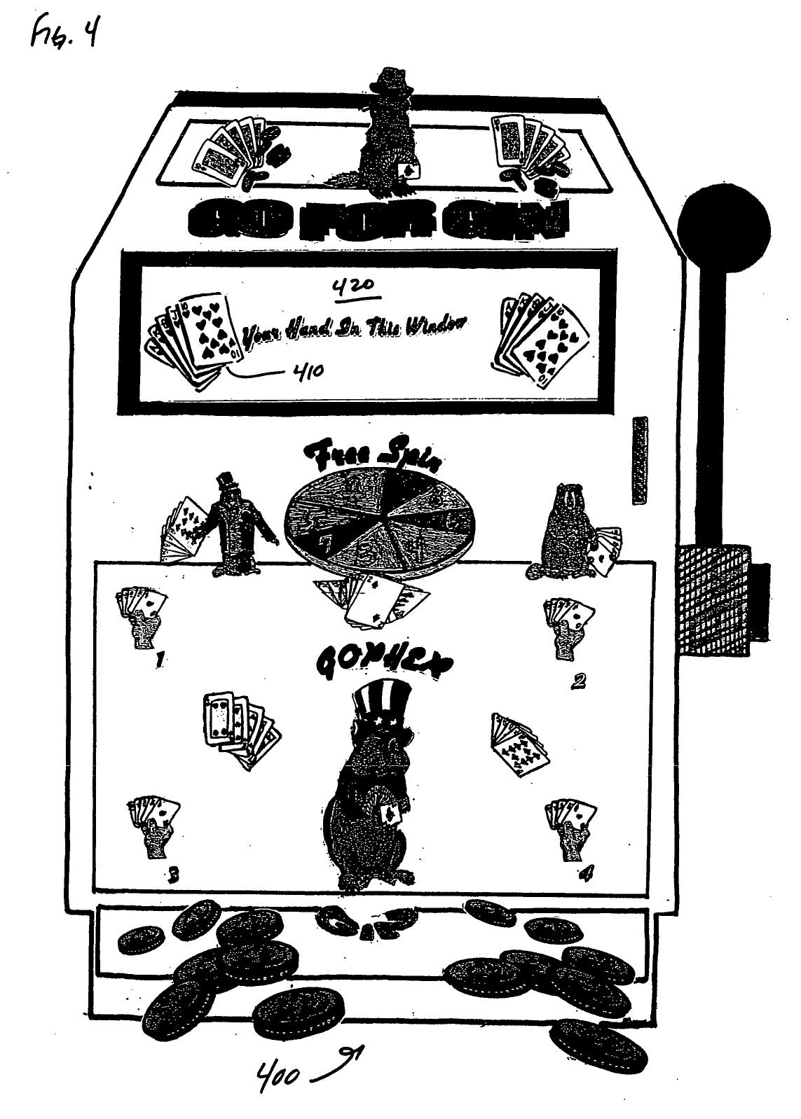

FIGS. 1 and 3A-3D illustrate a manner of play of a card game 10 of the present invention referred to hereinafter as CASINO GIN™. In a preferred embodiment, the CASINO GIN™ game 10 is a variation of the aforementioned Gin Rummy-type card game. In the CASINO GIN™ game 10, players place wagers in at least two “pots.” A pot includes wagers placed by each of the players. The wagers may be of a predetermined amount, e.g., a minimum monetary amount specified by the establishment conducting the game (e.g., a casino, card room or the like), or within a predetermined range of amounts set by the establishment. In one embodiment, illustrated in FIGS. 2A and 2B, a first pot 20 holds wagers 22 placed by two players on the results of play of a hand of the CASINO GIN™ game 10, and a second pot 30 holds wagers 32 placed by all players on the results of play of a complete game of CASINO GIN™. The first pot 20 is paid to the player that wins a corresponding hand of the CASINO GIN™ game 10. The second pot 30 is paid to the player that accumulates the predetermined number of points needed to win the CASINO GIN™ game 10.

While the present invention has many possible embodiments, a general overview of play of the CASINO GIN™ game 10 follows. The CASINO GIN™ game 10 may include a plurality of card receiving players 40 (Player 1-Player 6) and a dealer 42, who supervises and does not participate in the CASINO GIN™ game 10. In one embodiment, the dealer 42 greets the players 40 and instructs the players 40 to initially draw a card from a deck of playing cards 50 (Block 100) to determine seating about a playing area such as for example, a gaming table 60. In one embodiment of the present invention, two of the players 40 compete against each other in each hand of the CASINO GIN™ game 10. At Block 110, a first player in each pairing (e.g., player 1) is designated as a primary player, in accordance with the card selected by each player in the initial draw (e.g., players drawing the highest point value cards are primary players), while a second player (e.g., player 2) is designated as a secondary player. In the six player example illustrated in FIG. 1, player 1, player 3 and player 5 are primary players and player 2, player 4 and player 6 are secondary players in three individual pairings of players. As described below, the designation as a primary or a secondary player dictates variations in play of the CASINO GIN™ game 10. At Block 120, the dealer 42 provides each pairing a deck of playing cards 50.

Before a first hand is dealt, each of the players 40 (e.g., player 1-player 6) places a wager on the anticipated results of the game 10 (at Block 130) and a wager (e.g., ante) of a hand of play for their respective pairings (at Block 140). The first pot 20 holds the wagers 22 placed by each of the players 40 on the outcome of the hand played by the pairing and the second pot 30 holds the wagers 32 placed by each of the players 40 on the outcome of the game 10. FIGS. 2A and 2B illustrate one embodiment of the hand and game pots 20 and 30 in greater detail. As shown in FIG. 1, there are three hand pots 20 and one game pot 30. More or less hand pots 20 may be played depending on the number of pairings at a table 60, but there is always at least one hand pot 20 and one game pot 30.

At Block 150, the dealer 42 reviews the hand and game pots 20 and 30 and determines a house rake 24 and 34, respectively. In one embodiment, the house rake is a percentage of the respective hand and game pots 20 and 30 that are provided to the establishment in consideration for providing the facilities supporting the CASINO GIN™ game 10. Once the wagers are made and the rake determined, play of the game and first hand begins.

At Block 160, one of the players (e.g., the primary players) of each pairing deals each of the players 40 in the pairing a predetermined number of playing cards from the deck of cards 50, e.g., ten cards, places one card 52 in a face up position, and places the remaining, undealt cards 50 in a face down position. Each player may inspect the cards in their hands, which are labeled in FIG. 1 as cards 50₁ to 50₆ corresponding to player 1 to player 6, respectively. At Block 170 the dealer 42 marks the initial up card of each of the respective pairings. In one embodiment, similar to the Oklahoma variation of Gin Rummy, the up card 52 determines the maximum count of unmatched cards with which a player may knock. In one embodiment, the dealer 42 marks the initial up card 52 in a predetermined location 62 on the gaming table 60 for each of the pairings so that the knock value is readily apparent as play of a hand continues.

Play continues at Block 180 (FIG. 3B) when the primary player (e.g., player 1) from each of the pairings reviews the up card 52 and decides whether they wish to draw that card. If the primary player does not draw the up card 52, play passes along a “NO” path from Block 180 to Block 190. At Block 190, the secondary player (e.g., player 2) is given the option to draw the up card 52. If the secondary player does not draw the up card, play passes along a “NO” path from Block 190 to Block 200. At Block 200, the primary player draws a card from the remaining undealt deck of cards 50. Similar to the conventional rules of Gin Rummy, at Block 210 the primary player discards either the drawn card (as long as the player did not draw the up card 52) or another card from his or her hand. The discarded card becomes the up card 52 for the next player (e.g., the secondary player).

Referring again briefly to Block 180, if the primary player decides to draw the up card 52, play passes along a “YES” path to Block 185 where the primary player draws the up card 52. At Block 187, the primary player then discards a card and the discarded card becomes the up card for the next player. Alternatively, referring again to Block 190, if the secondary player decides to draw the up card 52, play passes along a “YES” path to Block 220 where the secondary player draws the up card 52. At Block 230, the secondary player discards a card and the discarded card becomes the up card 52 for the next player.

Once either the primary player discards a card (at either Block 187 or Block 210) or the secondary player discards a card (at Block 230), play passes to Block 240 where either of the players decides whether he or she wishes to knock. If the player does not knock, play passes along a “NO” path to Block 250 where the number of undealt cards 50 is examined. If there are not more than a predetermined number of undealt cards, e.g., at least two undealt cards 50, play of the hand ends at Block 260. No score is awarded to either of the players, and the players must re-ante into the hand pot 20 (e.g., pot 1). At Block 270 the hand is replayed by passing back to Block 150 (FIG. 3A) where the dealer 42 determines the house rake of the hand pot 20.

If there are enough undealt cards 50, play of the hand continues at Block 280 (FIG. 3C) where a next one of the players 40 in the pairing decides to draw a card from the undealt cards 50 or the up card 52. Once a card is drawn, another card in the player's hand is discarded (at Block 290). Play continues by passing back to Block 240 (FIG. 3B) until one of the players 40 of the pairing knocks (at Block 240) or there are not enough undealt cards 50 remaining to continue play (at Block 250).

Referring again to Block 240 (FIG. 3B), if a player knocks, play continues along a “YES” path from Block 240 to Block 300 (FIG. 3C). At Block 300, each of the players 40 in the pairing displays his or her cards in a face up manner. As in a conventional game of Gin Rummy, the knocking player may accumulate points both from the fact that he or she knocked and from an accumulation of points from the cards held by the non-knocking players. Rules may vary for determining the points derived from knocking and from the cards in other players' hands. One embodiment for determining points is illustrated below. It should be appreciated however, that it is within the scope of the present invention to implement other scoring systems.

At Block 310, it is determined whether the knocking player has gin, e.g., all cards in the knocking player's hand are in sets and there are no unmatched cards. If the knocking player does not have gin, play passes along a “NO” path from Block 310 to Block 320. At Block 320, a difference is determined between the unmatched cards of the knocking player and the non-knocking player. In accordance with its supervisory role, the dealer oversees this determination. If the non-knocking player has the same or a lesser point value of unmatched cards, then the knocking player has been undercut. If undercut, the non-knocking player receives a bonus score and is determined the winner of the hand (at Block 330). In one embodiment, a score of twenty points is given to the non-knocking player for undercutting the knocking player. Additionally, in one embodiment, the non-knocking player is given points equal to the difference between the knocking player's and non-knocking player's unmatched cards. If the knocking player is not undercut, play passes along the “NO” path from Block 320 to Block 340 where the non-knocking player may lay off cards onto sets of the knocking player's cards to reduce the point earned by the knocking player as is generally known within rummy-type games. If the knocking player has gin, play passes along a “YES” path from Block 310 to Block 350. At Block 350, the knocking player receives a bonus score since he or she knocked with gin. In one embodiment, the bonus score is equal to thirty points.

Whether the knocking player has gin or not, play passes to Block 360 (e.g., from either Block 340 or Block 350). At Block 360, a determination is made as to what, if any, additional points the knocking player may receive from the hands of the non-knocking player. All of the players 40, knocking and non-knocking, count the total point value of their unmatched cards. If the knocking player's count is lower than a non-knocking player, the knocking player's score is increase in points equal to the difference between the two counts. For example, if the knocking player has three unmatched cards, an ace, a two of clubs and a three of diamonds, then the knocking player's point value is equal to six. If one of the non-knocking players has four unmatched cards, a five of hearts, a six, eight and ten of diamonds, then the non-knocking player's point value is equal to twenty-nine. In which case, the knocking player's score is increased in points corresponding to the difference in points between his or her hand and the non-knocking player's hand, a total of twenty-three points (twenty-nine minus six). Additionally, the knocking player is declared the winner of the hand.

Play then passes from Block 360 to Block 370 (FIG. 3D). At Block 370, the dealer 42 or establishment overseeing the game pays or credits the winning player's account the wagers 22 accumulated in the first pot 20 (e.g., the hand pot). At Block 380, a determination is made as to whether the knocking player's score or the non-knocking player's score exceeds a predetermined score suitable for winning the CASINO GIN™ game 10. In one embodiment, the predetermined game winning score is a score of at least one hundred and fifty points. It should be appreciated that two or more hands of the CASINO GIN™ game 10 may be played concurrently. Therefore, a winner or winners of the CASINO GIN™ game 10 may be a player from another pairing.

If the knocking player's or non-knocking player's score is equal to or exceeds the predetermined game wining score play passes along a “YES” path from Block 380 to Block 390. At Block 390, the dealer 42 or establishment overseeing the game pays or credits the player's account the wagers 32 accumulated in the game or second pot 30 and play of the CASINO GIN™ game 10 ends.

If no player's score is equal to or exceeds the predetermined game winning score play passes along a “NO” path from Block 380 to Block 395. At Block 395 a new hand for the pairing begins as play then passes from Block 395 back to Block 140 (FIG. 3A) where each of the players places wagers 22 on a next hand. Play continues through a number of hands as outlined above until a player wins the CASINO GIN™ game 10 by achieving the requisite number of points to win the CASINO GIN™ game 10.

While the inventive CASINO GIN™ game 10 has been described and illustrated in connection with preferred embodiments, many variations and modifications, as will be evident to those skilled in this art, may be made without departing from the spirit and scope of the invention. The invention thus not to be limited to the precise details of methodology set forth above as such variations and modification are intended to be included within the scope of the invention.

For example, while described above as a game suitable for play in a gaming establishment such as, for example, a casino, card room or the like, the inventive card game 10 may be played as a leisure activity where wagers are non-binding, that is, do not represent a monetary value.

Additionally, it should be appreciated that it is within the scope of the present invention for the above described live card game format of the game 10 to be implemented in an electronic video game format. The contemplated electronic video game format is similar to a conventional electronic video poker device commonly employed in casinos and other gaming establishment. In this regard, FIG. 4 illustrates an electronic format 400 of the inventive CASINO GIN™ game 10 referred to as “GO FOR GIN.” In the electronic video format 400, a player competes against one or more “computerized” hands. In the electronic video format 400, each players' hand is comprised of card representations 410 displayed on a video screen 420, with game operation controlled by suitable program instructions stored in a memory device as is generally known in the art.

Security Features.

In one embodiment, security features are implemented to minimize occurrences of improper play. For example, as shown in FIG. 1, a tray 56 contains the pile of discarded cards (e.g., the current and previous up cards 52) and the deck of playing cards 50 for each pairing is contained within a conventional card shoe 56. It should be appreciated that it is within the scope of the present invention to incorporate other security features as are generally known in the art.

What is claimed is:

1. A method for playing a card game by a plurality of players, the method comprising the steps of:
pairing the plurality of players;
providing a plurality of playing cards to each of the pairings, each card having an established numerical value;
establishing a target numerical value for completion of the card game;
each of the plurality of players placing a first wager on results of a play of a hand of the card game and a second wager on results of a complete play of the card game;
determining, by a supervisor of the game, a percentage of the wagers to compensate the supervisor;
dealing a plurality of playing cards to each player in the pairing in a face down manner, placing one card in a face up manner and placing the remaining undealt cards in a face down manner;
marking, by the supervisor, the face up card to determine a minimum numeric value of cards to signal an end of a hand;
selecting a first player within each pairing;
permitting the first player an option of drawing the face up card;
if the first player does not draw the face up card, permitting the second player in the pairing an option of drawing the face up card, and if the second player does not draw the face up card, drawing, by the first player, a top card of the remaining undealt cards;
discarding, by the player that drew a card, a card from among the plurality of playing cards;
if possible, signaling, by one of the first and the second player, an end of a hand of play, wherein said signaling step is followed by steps of:
displaying, by each of the players in the pairing, the playing cards held by each of the players;
determining a numeric value representing a difference in unmatched cards held by each of the players in the pairing;
tallying a score, in accordance with predetermined rules, for the signaling player representing a numeric value assigned for signaling the end of the hand and the numeric value representing the difference in unmatched cards;
paying the signaling player the first wagers; and
if the signaling player's score is greater than the target numeric value for completion of the game, paying the signaling player the second wagers and ending complete play of the card game,
else beginning a next hand of the card game by performing the aforementioned dealing, marking, selecting, drawing, discarding and, if possible, signaling steps; and
if it is not possible for the player that discarded to signal an end of a hand, permitting a next sequential one of the players to perform the aforementioned drawing, discarding and, if possible, signaling steps.

2. The method of claim 1 wherein the target numerical value for completion of the card game is a value of one hundred and fifty points.

3. The method of claim 1 wherein the first wagers of each of the players are held in a first pot and the second wagers of each of the players are held in a second pot and the first and second pots are separate.

4. The method of claim 1 wherein the wagers in the first and the second pot represent one of a monetary sum of money, points and prizes.

5. The method of claim 1 wherein the plurality of playing cards dealt to each of the players is comprised of ten playing cards.

6. The method of claim 1 wherein the first player is selected by an initial drawing of one card by each of the players in the pairing and the first player drawing the highest point value card.

7. The method of claim 1 wherein when in the discarding step the discarding player is not permitted to discard the face up card if it was just drawn.

8. The method of claim 1 wherein prior to the determining the difference step, non-signaling players may layoff unmatched cards onto sets of the signaling players cards.

9. The method of claim 8 wherein the non-signaling players are not permitted to layoff cards if the signaling player has no unmatched cards.

10. The method of claim 1 wherein the tallying step includes:
adding a numeric value of thirty points to the signaling player's score if the signaling player has no unmatched cards in its hand.

11. The method of claim 1 further including:
ending a hand of play of the card game and performing the dealing, selecting, drawing, discarding and, if possible, signaling steps, if there are less than a minimum predetermined number of remaining undealt cards.

12. The method of claim 11 wherein the minimum predetermined number of remaining undealt cards is two cards.

13. The method of claim 1 wherein the card game is played at a table in a gaming establishment.

14. The method of claim 1 wherein the card game is implemented in an electronic video game.

15. A game of chance played by a plurality of players, wherein the plurality of players are paired, the game of chance comprising:
a plurality of playing cards for each of the pairings of players, each card having an established numerical value;
a first pot including a first wager placed by each of the players in the pairing on results of a play of a hand of the game; and
a second pot including a second wager placed by each of the plurality of players on results of a complete play of the game;
whereby a hand of the game is played when one of the players in each pairing deals a predetermined number of the playing cards in a face down manner, places one card in a face up manner and places the remaining undealt cards in a face down manner and each of the players in a pairing selectively draws one card from either a top card of the remaining undealt cards or the face up card, discards a card and, if possible, wins the hand of play by arranging cards in one of a number of predetermined sets, wherein the winning player receives the first wagers in the first pot and points applied to a total score needed to win the game;
whereby a plurality of hands of the game are played until at least one of the plurality of players accumulates the total score needed to win the game, wherein the player accumulating the winning total score receives the second wagers in the second pot and play of the game ends.

16. An electronic game of chance played by at least one player against a computerized representation of a dealer, the game of chance comprising:
a computer processing unit;
a display unit operatively coupled to the processing unit;
a memory device operatively coupled to the processing unit; and
application programming code executing on the processing unit and programmed to exhibit, on the display unit, a graphic representation of a plurality of playing cards, each representation having an established numerical value; the code defining a first pot including a first wager placed by the at least one player on results of a play of a hand of the game and a second pot including a second wager placed by the at least one player on results of a complete play of the game;
whereby a hand of the game is played when the at least one player instructs the application programming code to permit the dealer to deal a predetermined number of the playing cards in a face down manner, places one card in a face up manner and places the remaining undealt cards in a face down manner, wherein the at least player and the dealer selectively draw one card from either a top card of the remaining undealt cards or the face up card, discard a card from their respective hands and, if possible, arrange the cards in their hands in one of a number of predetermined sets to win the hand, wherein either the at least one player or the dealer receive the first wagers in the first pot and points applied to a total score needed to win the game;
whereby a plurality of hands of the game are played until the at least one player or the dealer accumulate the total score needed to win the game, wherein when the at least one player or dealer accumulate the winning total score, the winning player receives the second wagers in the second pot and play of the game ends.
